(19) United States
(12) Patent Application Publication
(10) Pub. No.: US 2005/0267789 A1
(43) Pub. Date: Dec. 1, 2005

(54) Portal generation for industry specific business roles

(76) Inventors: Anthony Satyadas, Lexington, MA (US); Birendro Roy, Baton Rouge, LA (US); Amar P. Patel, Homestead, FL (US); Roy W. Bowen, Lancaster, WA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(21) Appl. No.: 10/852,790

(22) Filed: May 25, 2004

(51) Int. Cl. G06F 17/60

(52) U.S. Cl. 705/7

(57) ABSTRACT

Described is a method for software developers to generate a portal for a business role. The portal includes portlets arranged in a page layout for accessing web based resources. Industry specific information associated with the business role is mapped to web based resources. Portlets for providing data associated with the web based capabilities are identified and assembled in the layout of the portal. The developer can modify the layout and change a portlet associated with a particular capability. The method enables existing knowledge associated with a business role to be integrated into a rapid development tool. Fast portlet development functionality is combined with an automated workplace creation technique. Consequently, software products can be delivered to the marketplace in less time than products generated through traditional software development techniques.

### FIELD OF THE INVENTION

The invention relates generally to a method for developing portals. In particular, the invention relates to a method for defining and deploying industry role specific portals referred to as e-workplaces and on demand workplaces.

### BACKGROUND OF THE INVENTION

As use of computer networks and the Internet continues to expand, so to has the interest in portals. A portal is a web based application that provides a single personalized point of access for presentation of information and resources to a user or a group of users. A common portal is the web page presented to a user when first accessing the Internet or a computer network. Web content received from various content providers is aggregated and displayed in the portal web pages. The content can include static information and dynamic data streams. The portal can include various personalization features to provide customized content to the user. In some instances, the portal is configured as multiple pages having linked capabilities. Advantageously, portals reduce the need to learn a new interface for each web based application or resource accessed by a user and can simplify the interaction of the user with frequently referenced information sources.

Portals enable the display of web components, or “portlets”, for self-contained applications or content. Portlets generally are developed according to standards that allow the portlets to be “plugged into” any portal supporting the standards. By way of example, portlets can include e-mail, search engines, news sites, online shopping, chat sites, discussion forums and various other information sources including weather sites, map sites, stock quote sources, and various applications from commercial off the shelf (COTS) to homegrown, legacy and new applications.

Portals can be used in a business environment to provide users with a common set of resources and data. For example, a business may have numerous employees performing similar job functions and having a need to access similar business-related information sources. Thus it is beneficial to provide a similar portal for each employee engaged in a common business role. Software developers, however, must expend significant time and effort researching business roles and processes to develop products for enterprise software customers. In particular, development of a new portal with an appropriate set of portlets is generally necessary to satisfy the customer's requirements for a particular industry role. Moreover, a new interface is learned for each application or resource accessed by an end user.

What is needed is a development tool to enable rapid development of portals relevant to specific workplace roles. End users should benefit from a consistent interface which increases ease of use of the associated applications and resources. The present invention satisfies this need and provides additional advantages.

### SUMMARY OF THE INVENTION

In one aspect, the invention features a method for generating a portal for a business role. The portal includes portlets for accessing web based capabilities. The portlets are configured in a page layout. Industry specific information associated with the business role is mapped to the web based capabilities. Portlets adapted to access the mapped web bases capabilities are identified and assembled in the page layout of the portal. In one embodiment, the method also includes determining the industry specific information associated with the business role.

In another aspect, the invention features a computer program product for generating a portal for a business role. The portal includes portlets configured in a page layout for accessing web based capabilities. The computer program product includes a computer useable medium having embodied therein program code for mapping industry specific information associated with the business role to the web based capabilities, program code for identifying portlets adapted to access the mapped web based capabilities, and program code for assembling the identified portlets in the page layout of the portal.

In still another aspect, the invention features a computer data signal embodied in a carrier wave for generating a portal for a business role. The portal includes portlets configured in a page layout for accessing web based capabilities. The computer data signal includes program code for mapping industry specific information associated with the business role to the web based capabilities, program code for identifying portlets adapted to access the mapped web based capabilities, and program code for assembling the identified portlets in the page layout of the portal.

In yet another aspect, the invention features an apparatus for generating a portal for a business role. The portal includes portlets configured in a page layout for accessing web based capabilities. The apparatus includes means for mapping industry specific information associated with the business role to the web based capabilities, means for identifying portlets adapted to access the mapped web based capabilities; and means for assembling the identified portlets in the page layout of the portal.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is an illustration of a networked computer environment having a portal server and distributed users.

FIG. 2 depicts a portal for user access to web based information and resources.

FIG. 3 is a block diagram illustrating the perspectives of software developers with respect to the presentation, application and data tiers associated with an embodiment of a method for generating a portal for an industry specific business role according to the invention.

FIG. 4 is a block diagram illustrating the perspective of end users with respect to the presentation, application and data tiers associated with an embodiment of a method for generating a portal for an industry specific business role according to the invention.

FIG. 5 is a block diagram illustrating the interaction of software components associated with an embodiment of a method for generating a portal for an industry specific business role according to the invention.

FIG. 6 is a flowchart representation of an embodiment of a method for generating a portal for an industry specific business role according to the invention.

### DETAILED DESCRIPTION

In brief overview the present invention relates to a method for generating a portal to execute structured and ad-hoc business processes for an industry specific business role. The portal includes portlets for accessing web based applications and resources. Industry specific information related to the business role is determined and mapped to web based resources. Portlets are identified based on the mapping and are assembled in the portal according to a page layout (i.e., page structure). The page layout is determined according to the industry specific information and can be modified upon the occurrence of predetermined business process events. The modified layout can be dependent upon information unique to the business process event. Alternatively, the layout of the portal can change as part of a natural progression in a business process in which events occur in a controlled or sequential manner. In either situation, the portal is reconfigured according to the new page layout.

The method of the invention enables existing knowledge associated with a business role to be integrated into a rapid development tool. Fast portlet development functionality is combined with an automated workplace creation technique so that software developers can concentrate on software consumer customization instead of generating a role based portal from scratch. Consequently, related software products can be delivered to the marketplace in less time.

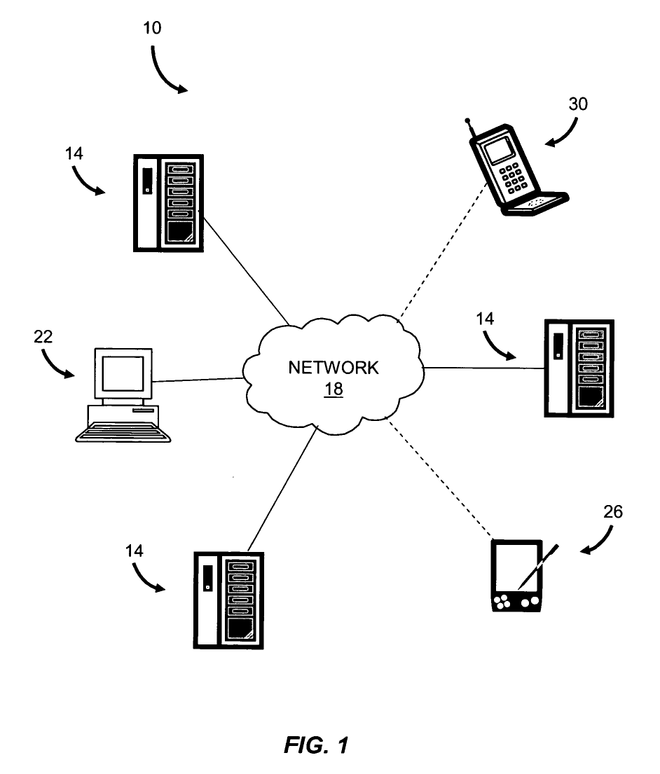

Referring to FIG. 1, a networked environment 10 in which software products generated according to the method of the invention may be used is depicted. The networked environment 10 includes servers 14 in communication with clients over a network 18. As illustrated, the clients include a personal computer (PC) 22, a personal digital assistant (PDA) 26 and a web enabled cell phone 30. Other devices capable of data communications with the servers 14 are also contemplated. The network 18 can be an intranet, the Internet or any network or combination of networks that supports the transmission of data between the server 14 and the clients. Each client includes a user interface for the presentation of text, images and graphics to a user.

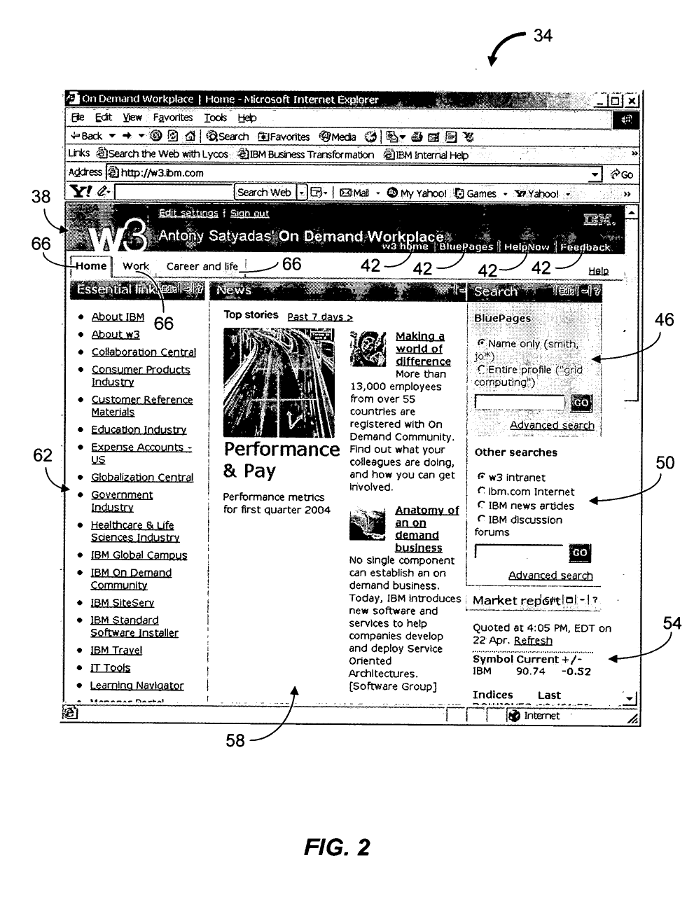

At the beginning of a user session, a user is provided with a portal page appropriate to the user's business role. FIG. 2 depicts an example of a portal page 34 customized according to the preferences of a user. The portal 34 includes banner section 38 that remains static during a user's session. The banner section 38 identifies the user and the user's employer, and includes tabs 42 to allow quick access to predefined functions (e.g., help and feedback) available through employer resources. The illustrated portal page 34 is the user's “home page” and includes a portlet 46 that provides a specific searching capability, a portlet 50 allowing the user to select other searches, and a stock quote portlet 54 providing stock market data. Another portlet 58 displays brief summaries of current “top stories” and includes hyperlinks allowing the user to display a story in its entirety. Another portlet 62 provides a list of “essential links” and includes vertically displayed links to various resources available from the employer and third parties. The portlets 46, 50, 54, 58 and 62 are arranged (i.e., positioned) according to a page layout associated with the home portal page 34. The home portal page 34 includes tabs 46 to provide access to other portal pages. Other portal pages typically provide portlets that are different than those of the home portal page 34, although one or more portlets can be similar or identical to portlets in the home page 34. In addition, the layout of other portal pages typically differs from the layout of the home page 34.

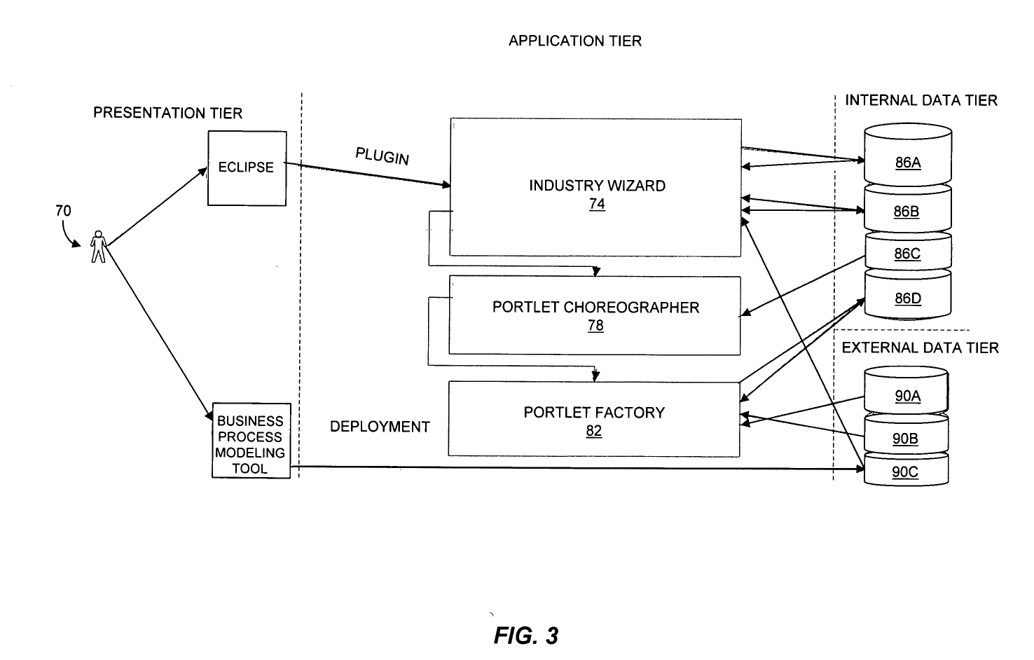

FIG. 3 illustrates a functional overview of an embodiment of a portal generation architecture from the software developer's perspective according to the invention. Software developers, business partners, business consultants, and systems integrators (generally developers 70) assist in the creation of plugins generated according to an Eclipse development environment although, in other embodiments, other development environments can be used. In the illustrated embodiment, an industry wizard 74, a portlet choreographer 78 and a portlet factory 82 are provided and interact with each other to produce a portal for a specific business role as described in more detail below. Internal data resources 86 are utilized (by performing read from and/or write to operations) during the process and include data storage allocated for industry business role task mappings 86A, task to capability mappings 86B and page templates (i.e., defined page layouts) 86C, and an internal portlet catalog 86D. External data resources 90 and capabilities utilized during the process include a Websphere Application Portlet Integrator (WPAI) 90A, an external business portlet catalog 90B and a business process model 90C. The WPAI 90A is a portlet builder that allows users to create and manipulate data in various applications. In other embodiments, WPAI 90A is replaced with other available software tools for rapid portlet development. The external portlet catalog 90B is a remote source of portlets that is accessed during the process to generate the desired portal. Similarly, the business process model 90C is a remote resource that can be implemented by the industry wizard 74 when performing industry business role mapping.

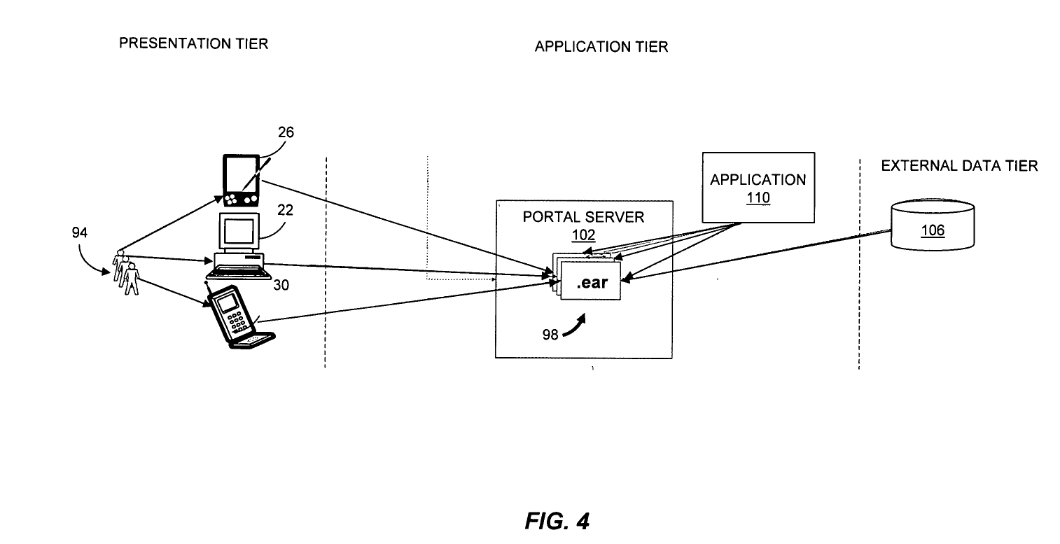

FIG. 4 illustrates an end user's interaction with a portal 98 generated according to the method of the invention. The end user 90 accesses the portal 98 from a portal server 102 having an associated database 106 using any of a variety of clients (e.g., a PC 22, a PDA 26 or a cell phone 30). The user executes an application 110 to provide the portal 98 with the appropriate portlets. The application 110 can reside on the client 22, 26 or 30, the portal server 102 or another server (not shown). The portal 98 developed according to the process enabled by the architecture illustrated in FIG. 3 is packaged, for example, as an ear file (i.e., Java enterprise application packaging unit).

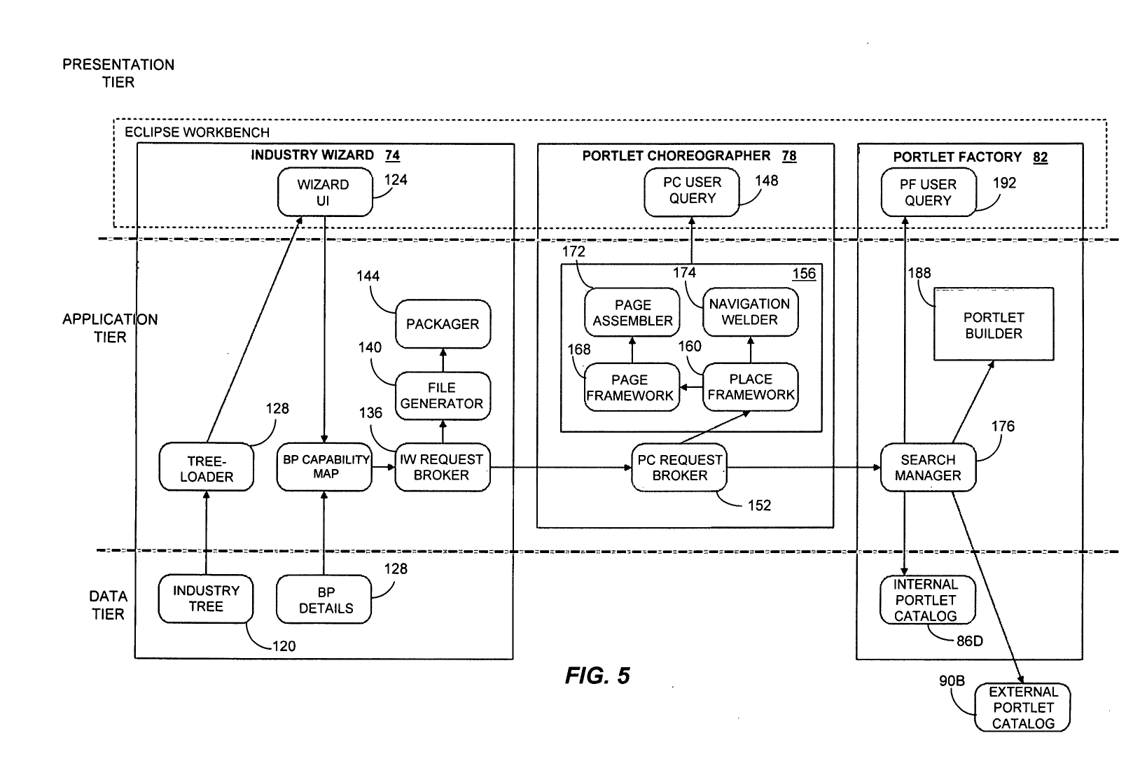

FIG. 5 is a block diagram illustrating the interaction of various software components for the industry wizard 74, the portlet choreographer 78 and the portlet factory 82 (see FIG. 3). The industry wizard 74 includes an industry tree 120 (e.g., an XML formal tile) providing valid industries, roles and business processes to a wizard user interface (UI) 124 when loaded by a treeloader component 128. A developer can select the desired elements from each industry, role and business process category. The developer selections and stored business process data 128 are provided to a capability mapper component 132. Business process data includes encapsulated details of all stored business processes, including component activities and tasks, and the capabilities associated with these tasks. The capability mapper 132 generates a sequence of sets of capabilities that represent elements of the identified business process. As used herein, a capability is a unit of functionality used in completing a portion of the business process. Generally, a capability represents functionality that can be provided by a single portlet. Capabilities can occur in series, in parallel or as a combination of series and parallel occurrences. A request broker 136 receives the sequence of sets of capabilities and arranged portlets provided by the portlet choreographer 78. A file generator 140 generates a basic site hierarchy based on the capability sets and the arranged portlets. The basic site hierarchy defines the “places” (set of page layouts that address the business processes associated with the business role) for each role and can provide default home pages. A packager component 144 generates a deployable archive (e.g., an .ear file) based on the portlets and any supporting files as defined in the basic site hierarchy.

The portlet choreographer 78 includes a request broker 152 which provides a single communication point to the industry wizard 74 and the portlet factory 82. The request broker receives the selected industry, role, business process and capability sets and generates a portal tree (i.e., a portal hierarchical structure) associated with the capability sets. The portal tree includes a place set, a page set, and “wiring” between portlets within a portal page and across multiple portal pages. A wired portlet refers to a portlet that communicates with at least one other portlet. Wired portlets can be on the same portal page or distributed across multiple portal pages. The wiring of portlets permits a determination of which portlets are displayed in the present portal page during a given point in the execution of a business process.

The portlet choreographer 78 also includes a user query component 148 that permits the developer to specify or change portions of the portal tree such as the placement of portlets within a page and the creation of places. Thus, a user query component 148 takes an existing data structure representing the portal tree and generates a modified portal tree structure according to developer's requested changes. In one embodiment, the user query 148 utilizes a graphical user interface to manipulate sections of the portal tree according to a drag and drop method. The modified portal tree structure can be an XML file updated according to the changes made by the developer.

The portlet choreographer 78 also includes a page factory module 156 that provides components having a range of functionalities. A place framework component 160 calls the user query component 148 to allow the developer to automatically or manually select the places for roles in the portal tree, and generates a set (or framework) of places. Automatic selection is based upon portal development history. Once all the places are created, the place framework component 160 creates a place shortcut/menu bar and calls the user query module 148 to modify or confirm the place shortcut/menu bar. Similarly, the page framework component 164 calls the user query component 148 to permit the developer to automatically or manually select page layouts, and generates a set of portal pages. Once all the pages are assembled, the page framework component 164 creates a page shortcut/menu bar and calls the user query module 148 to modify or confirm the page shortcut/menu bar. The page framework component 164 calls a page assembler component 172 which allows the developer to select portlets automatically or manually. The page assembler component 172 gathers the information associated with a page, including the specific portlets for the page, the initial layout of the portlets in the page and the wiring between the portlets. The developer can also interact with the page assembler component 172 to confirm the layout of the portlets on a page. A navigation welder component 174 “wires” the pages of a portal to enable portlets in one page to communicate in the desired way with portlets in other pages.

The portlet factory 82 includes a search manager component 176 that receives a capability request from the portlet choreographer 78 and coordinates the search for an appropriate portlet from one or more internal portlet catalogs 86D and external portlet catalogs 90B (also see FIG. 3). If no appropriate portlet is found, the search manager 176 accesses a portlet builder component 188 to generate a portlet for the required capability. Internal portlet catalogs 86D store portlets that have previously been used and which may have been accessed from an external source or generated in a previous implementation of the method. External portlet catalogs 90B store portlets made available by other users through independent data systems and can be used to implement a required capability. Although external portlet catalogs 90B may be available in formats not directly compatible with the format of internal portlet catalogs 86D, a catalog interface can be specified so that the external portlet catalogs 90B are accessed using an appropriate adapter. The portlet builder component 188 generates a portlet which implements a required capability when no existing portlet can be found. In one example, the portlet builder 188 is a component that encapsulates the functionality of WPAI or a similar application portlet builder. Finally, the portlet factory 82 includes a user query component 192 that asks the developer to specify a locally-stored portlet to implement a particular capability when no corresponding portlet is found in the portlet catalogs 86D, 90B and cannot be provided by the portlet builder 188.

It should be recognized that the above description of an embodiment of software components for the industry wizard 74, portlet choreographer 78 and portlet factory 82 are not limiting. Other combinations of software components providing similar functionality are also contemplated according to the invention.

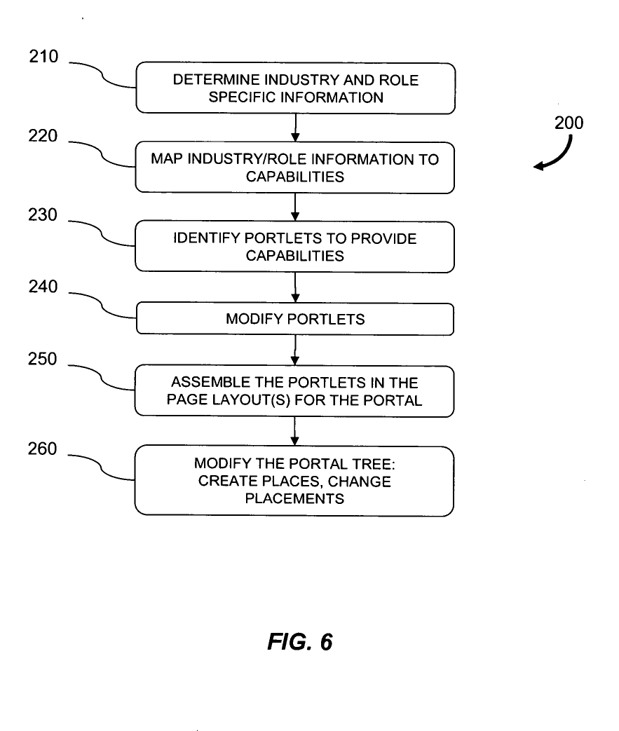

FIG. 6 illustrates an embodiment of a method 200 for generating a portal for a business role which can be implemented using the component architecture described above. The method 200 includes determining (step 210) industry specific information associated with the business role. The industry specific information is mapped (step 220) to a plurality of capabilities associated with the business role. Portlets which provide the capabilities are then identified (step 230). The developer can modify (step 240) the portlets via the portlet factory user query. For example, a developer may choose to select a local portlet if no appropriate portlet is found in the portlet catalogs or is generated by the portlet builder. The portlets are assembled (step 250) in one or more page layouts for the portal. Assembly can include the wiring of two or more portlets to achieve a desired dependence between the associated business process capabilities. The developer has the option of modifying (step 260) the portal hierarchy, for example, by creating new places and changing the placements in the page layouts.

While the invention has been shown and described with reference to specific embodiments, it should be understood by those skilled in the art that various changes in form and detail may be made therein without departing from the spirit and scope of the invention.

1. A method for generating a portal for a business role, the portal having a plurality of portlets for accessing web based capabilities, the portlets being configured in a page layout, the method comprising:
mapping industry specific information associated with the business role to the web based capabilities;
identifying portlets adapted to access the mapped web based capabilities; and
assembling the identified portlets in the page layout of the portal.

2. The method of claim 1 further comprising determining the industry specific information associated with the business role.

3. The method of claim 1 further comprising generating a modified page layout to be provided to a user in response to a determination of an occurrence of a business process event.

4. The method of claim 1 further comprising determining the page layout in response to the industry specific information.

5. The method of claim 1 further comprising wiring one of the portlets with at least one of the other portlets in the portal.

6. A computer program product for generating a portal for a business role, the portal having a plurality of portlets configured in a page layout for accessing web based capabilities, the computer program product comprising a computer useable medium having embodied therein program code comprising:
program code for mapping industry specific information associated with the business role to the web based capabilities;
program code for identifying portlets adapted to access the mapped web based capabilities; and
program code for assembling the identified portlets in the page layout of the portal.

7. The computer program product of claim 6 further comprising program code for determining the industry specific information associated with the business role.

8. The computer program product of claim 6 further comprising program code for generating a modified page layout to be provided to a user in response to a determination of an occurrence of a business process event.

9. The computer program product of claim 6 further comprising program code for determining the page layout in response to the industry specific information.

10. The computer program product of claim 6 further comprising program code for wiring one of the portlets with at least one of the other portlets in the portal.

11. A computer data signal embodied in a carrier wave for generating a portal for a business role, the portal having a plurality of portlets configured in a page layout for accessing web based capabilities, the computer data signal comprising:
program code for mapping industry specific information associated with the business role to the web based capabilities;
program code for identifying portlets adapted to access the mapped web based capabilities; and
program code for assembling the identified portlets in the page layout of the portal.

12. The computer data signal of claim 11 further comprising program code for determining the industry specific information associated with the business role.

13. The computer data signal of claim 11 further comprising program code for generating a modified page layout to be provided to a user in response to a determination of an occurrence of a business process event.

14. The computer data signal of claim 11 further comprising program code for determining the page layout in response to the industry specific information.

15. The computer data signal of claim 11 further comprising program code for wiring one of the portlets with at least one of the other portlets in the portal.

16. An apparatus for generating a portal for a business role, the portal having a plurality of portlets configured in a page layout for accessing web based capabilities, the apparatus comprising:
means for mapping industry specific information associated with the business role to the web based capabilities;
means for identifying portlets adapted to access the mapped web based capabilities; and
means for assembling the identified portlets in the page layout of the portal.

17. The apparatus of claim 16 further comprising means for determining the industry specific information associated with the business role.

18. The apparatus of claim 16 further comprising means for generating a modified page layout to be provided to a user in response to a determination of an occurrence of a business process event.

19. The apparatus of claim 16 further comprising means for determining the page layout in response to the industry specific information.

20. The apparatus of claim 16 further comprising means for wiring one of the portlets with at least one of the other portlets in the portal.
